(19) United States
(12) Patent Application Publication
(10) Pub. No.: US 2010/0199711 A1
(43) Pub. Date: Aug. 12, 2010

(54) BEVERAGE COOLER AND DISPENSER ASSEMBLY

(76) Inventor: Jame E. Smith, Eugene, OR (US)

Correspondence Address: JERRY HAYNES LAW, 2 N OAKDALE AVENUE, MEDFORD, OR, 97501, US

(21) Appl. No.: 12/613,201

(22) Filed: Nov. 5, 2009

Related U.S. Application Data
(60) Provisional application No. 61/198,630, filed on Nov. 7, 2008.

(51) Int. Cl. F25D 3/08; B65D 25/40; A45F 3/14; B67D 7/80

(52) U.S. Cl. 62/457.4; 222/566; 224/257; 222/146.6

(57) ABSTRACT

A beverage cooler and dispenser assembly includes a beverage container having a dispensing nozzle, a cooling pack receiving the beverage container and a beverage container carrier receiving the beverage container and the cooling pack.

### CROSS-REFERENCE TO RELATED APPLICATIONS

This application claims the benefit of and incorporates by reference in its entirety U.S. provisional application No. 61/198,630, filed Nov. 7, 2008 and entitled “Carbonated/non-carbonated dispenser/cooler back-pack”.

### FIELD OF THE INVENTION

The disclosure relates to apparatus for dispensing beverages. More particularly, the disclosure relates to a beverage cooler and dispenser assembly which is highly portable and suitable for cooling and dispensing beverages.

### BACKGROUND OF THE INVENTION

Coolers and the like are popular devices used to maintain beverages in a cold condition. A conventional cooler typically includes insulated walls and an insulated bottom that define a cooler interior. A detachable insulated lid fits on the walls to close the cooler interior. Water or other beverage is placed in the interior of the cooler to keep the water or beverage cool. A spigot may be provided in the lower portion of the cooler wall to facilitate dispensing of water or beverage from the interior of the cooler as desired.

One of the limitations of conventional beverage coolers and dispensers is their lack of portability. Another limitation of conventional beverage coolers and dispensers is the difficulty which may be encountered in dispensing the beverage from the cooler. A beverage cooler and dispenser assembly which is therefore highly portable and suitable for cooling and dispensing beverages is needed.

### SUMMARY OF THE INVENTION

A beverage cooler and dispenser assembly includes a beverage container having a dispensing nozzle, a cooling pack receiving the beverage container and a beverage container carrier receiving the beverage container and the cooling pack.

### BRIEF DESCRIPTION OF THE DRAWINGS

The disclosure will now be made, by way of example, with reference to the accompanying drawings, in which:

FIG. 1 is a side view of a beverage container enclosure, dispensing hose and spigot of an illustrative embodiment of a beverage cooler and dispenser assembly;

FIG. 2 is a perspective view of a beverage container enclosure of an illustrative embodiment of the beverage cooler and dispenser assembly, more particularly illustrating a structural brace (shown in phantom) provided in the beverage container enclosure;

FIG. 3 is an exploded perspective view of an illustrative embodiment of the beverage cooler and dispenser assembly;

FIG. 4 is a cross-sectional view of a beverage container enclosure of an alternative illustrative embodiment of the beverage cooler and dispenser assembly;

FIG. 5 is an exploded perspective view illustrating placement of a beverage container enclosure inside a cooling pack of an illustrative embodiment of the beverage cooler and dispenser assembly;

FIG. 6 is a front view of an alternative illustrative embodiment of the beverage cooler and dispenser assembly which utilizes the beverage container enclosure illustrated in FIG. 4;

FIG. 6A is a rear view of the beverage cooler and dispenser assembly illustrated in FIG. 4; and

FIG. 7 is an exploded perspective view illustrating placement of a beverage container enclosure inside a cooling pack of alternative design according to another alternative illustrative embodiment of the beverage cooler and dispenser assembly.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

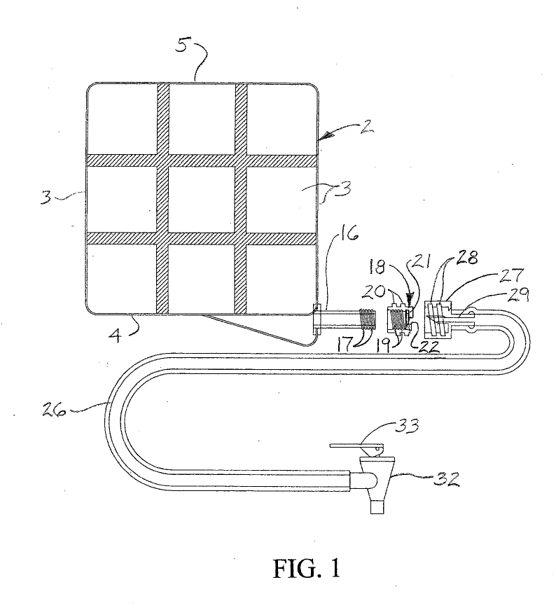

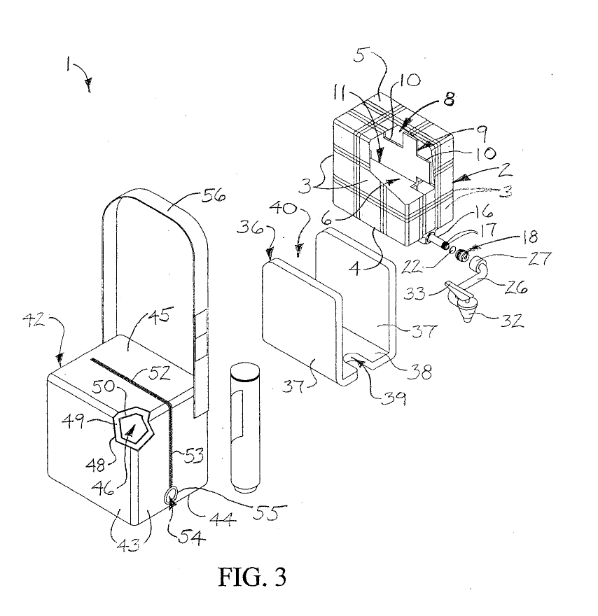

Referring initially to FIGS. 1-3 and 5 of the drawings, an illustrative embodiment of the beverage cooler and dispenser assembly, hereinafter assembly, is generally indicated by reference numeral 1 in FIG. 3. The assembly 1 may include a beverage container 2 which is adapted to contain a liquid beverage (not illustrated). A cooling pack 36 may be adapted to receive and cool the beverage container 2. A beverage container carrier 42 may be adapted to receive the cooling pack 36 and the beverage container 2 to render portability to the beverage container 2. The structural details of the beverage container 2, the cooling pack 36 and the beverage container carrier 42 will be hereinafter described.

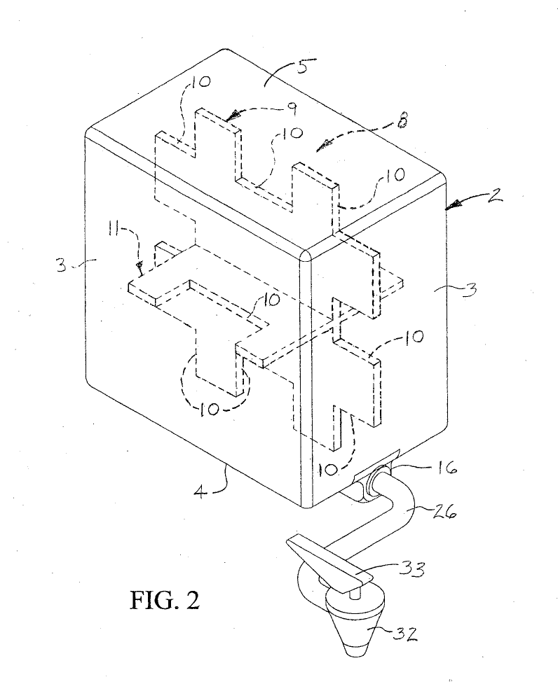

As illustrated in FIGS. 2 and 3, in some embodiments the beverage container 2 of the assembly 1 may include beverage container walls 3, a beverage container bottom 4 and a beverage container top 5 which together define a beverage container interior 6 (FIG. 3). In other embodiments, the beverage container 2 may have alternative shapes. In use of the beverage cooler and dispenser assembly 1, which will be hereinafter described, the beverage container interior 6 of the beverage container 2 contains a supply of water or beverage (not illustrated) such as carbonated or non-carbonated pre-mixed beverages, for example and without limitation.

Each of the beverage container walls 3, the beverage container bottom 4 and the beverage container top 5 of the beverage container 2 may be one or multiple layers of food grade flexible plastic or other suitable material such as corrugated cardboard, for example and without limitation. In some embodiments, the beverage container walls 3, the beverage container bottom 4 and the beverage container top 5 may each be reinforced with MYLAR (trademark). As illustrated in FIGS. 1 and 2, in some embodiments a structural brace 8 may be provided in the beverage container interior 6 of the beverage container 2 to reinforce the beverage container walls 3, the beverage container bottom 4 and the beverage container top 5. The structural brace 8 may be made of a corrosive-resistant or acid-resistant material such as a food-grade plastic material, for example and without limitation. In some embodiments, the structural brace 8 may include a main brace panel 9 and a transverse brace panel 11 which intersects and is oriented in generally perpendicular relationship with respect to the main brace panel 9. The main brace panel 9 of the structural brace 8 may engage and extend between a first opposing pair of the beverage container walls 3 and between the beverage container bottom 4 and the beverage container top 5. The transverse brace panel 11 of the structural brace 8 may engage and extend between the second opposing pair of the beverage container walls 3. Beverage flow notches 10 may be provided in each of the main brace panel 9 and the transverse brace panel 11 to facilitate flow of beverage (not illustrated) throughout the beverage container interior 6. The structural brace 8 may be adapted to prevent a convexing effect of the beverage container walls 3, the beverage container bottom 4 and the beverage container top 5 of the beverage container 2 due to the pressures which may be induced by carbonated and non-carbonated beverages contained in the beverage container interior 6.

A dispensing nozzle 16 may extend from the beverage container 2 in fluid communication with the beverage container interior 6. A dispensing hose 26 may be detachably connected to the dispensing nozzle 16. The dispensing hose 26 may be a food-grade plastic material, for example and without limitation. A spigot 32 may be provided on the dispensing hose 26. The spigot 32 may be fitted with a spigot lever 33 to facilitate selective dispensing of beverage from the beverage container interior 6 of the beverage container 2, through the dispensing nozzle 16 and from the spigot 32, respectively, responsive to manipulation of the spigot lever 33.

In some embodiments, the dispensing hose 26 may be detachably connected to the dispensing nozzle 16 through a nozzle cap 18. The nozzle cap 18 may detachably engage the dispensing nozzle 16 according to any suitable technique which is known by those skilled in the art. In some embodiments, interior cap threads 19 in the nozzle cap 18 may detachably engage exterior nozzle threads 17 provided on the dispensing nozzle 16. A pierceable seal 21 may be provided in the nozzle cap 18. A cap opening 22 may be provided in the nozzle cap 18 adjacent to the seal 21.

The dispensing hose 26 may be detachably connected to the nozzle cap 18 according to any suitable technique which is known by those skilled in the art. In some embodiments, a hose connector 27 may be provided on the dispensing hose 26. Multiple connector threads 28 provided in the hose connector 27 may detachably engage exterior cap threads 20 provided on the nozzle cap 18. A canula 29 may be centered in the hose connector 27 and disposed in fluid communication with the dispensing hose 26. As the hose connector 27 is attached to the nozzle cap 18, the canula 29 may be adapted to extend through the cap opening 22 and pierce the seal 21 of the nozzle cap 18 and provide a fluid-tight seal between the dispensing nozzle 16 and the dispensing hose 26.

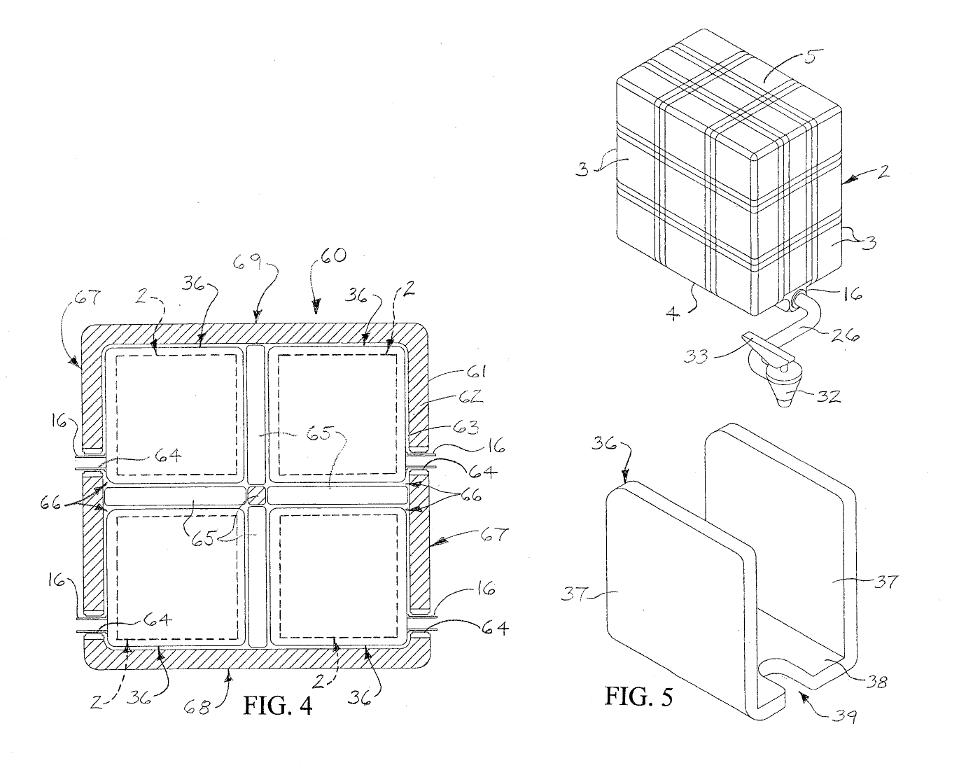

As illustrated in FIGS. 3 and 5, the cooling pack 36 may be adapted to receive and cool the beverage container 2 and the beverage contents (not illustrated) provided in the beverage container interior 6 by conduction. Accordingly, the cooling pack 36 may have any design which is suitable for the purpose. In some embodiments, the cooling pack 36 may include a pair of generally parallel, spaced-apart cooling pack side panels 37. A cooling pack connecting panel 38 may connect the cooling pack side panels 37. A cooling pack interior 40 may be defined by and between the cooling pack side panels 37 and the cooling pack connecting panel 38. As illustrated in FIG. 5, the beverage container 2 may be adapted for insertion in the cooling pack interior 40 between the spaced-apart cooling pack side panels 37. In some embodiments, a nozzle slot 39 may be provided in the cooling pack connecting panel 38 to accommodate the dispensing nozzle 16 when the beverage container 2 is seated in the cooling pack 36. Each of the cooling pack side panels 37 and the cooling pack connecting panel 38 may be adapted to contain a freezing liquid (not illustrated) such as water, for example and without limitation and may be a plastic or other thermally-conductive material which is suitable for the purpose.

The beverage container carrier 42 of the assembly 1 may be any size, shape and design which is suitable for containing and rendering portable the beverage container 2. As illustrated in FIG. 3, in some embodiments the beverage container carrier 42 may include carrier walls 43 and a carrier bottom 44 and a carrier top 45 provided on the carrier walls 43 and defining an enclosure interior 46. As further illustrated in FIG. 3, each of the carrier walls 43, the carrier bottom 44 and the carrier top 45 may have an outer layer 48, an inner layer 50 and a middle layer 49 sandwiched between the outer layer 48 and the inner layer 50. In some embodiments, the outer layer 48 may include cordura or vinyl-coated, backed or insulating material; the middle layer 49 may include poly-foam or other insulating material; and the inner layer 50 may include cordura or other insulating material.

An elongated access slit 52 may be provided in the beverage container carrier 42 to facilitate opening and closing the enclosure interior 46 of the beverage container carrier 42. In some embodiments, the access slit 52 may extend through the carrier top 45 and one of the carrier walls 43. The access slit 52 may be selectively opened and sealed using a zipper 53 or any other suitable fastening mechanism which is known by those skilled in the art. A nozzle opening 54 may be provided in one of the carrier walls 43 to accommodate the dispensing nozzle 16 when the beverage container 2 is placed in the beverage container carrier 42. The nozzle opening 54 may be reinforced with a reinforcing ring 55. In some embodiments, a carrying strap 56 may be provided on the beverage container carrier 42 to facilitate carrying of the assembly 1 in use.

In typical use of the assembly 1, water or beverage (not illustrated), hereinafter beverage, is placed in the beverage container interior 6 of the beverage container 2. In some embodiments, this may be accomplished by infusing the beverage into the beverage container interior 6 through the dispensing nozzle 16. In other embodiments, the beverage may be placed in the beverage container interior 6 using alternative methods known by those skilled in the art. After the cooling pack 36 is placed in a freezer (not illustrated) to freeze the water (not illustrated) or other freezing liquid inside the cooling pack side panels 37 and the cooling pack connecting panel 38 of the cooling pack 36, the beverage container 2 is placed in the cooling pack interior 40 between the cooling pack side panels 37. Therefore, the frozen liquid inside the cooling pack 36 cools the beverage inside the beverage container interior 6 by conduction through the beverage container walls 3 and the beverage container bottom 4 of the beverage container 2. The nozzle slot 39 provided in the cooling pack connecting panel 38 of the cooling pack 36 may accommodate the dispensing nozzle 16 to prevent frosting or freezing of the dispensing nozzle 16. The cooling pack 36 and the beverage container 2 which is contained therein may then be placed in the beverage container carrier 42 by opening the access slit 52, placing the beverage container 2 in the beverage container carrier 42 through the access slit 52, inserting the dispensing nozzle 16 of the beverage container 2 through the nozzle opening 54 provided in the beverage container carrier 42 and closing the access slit 52 using the zipper 53 or other fastening mechanism. The carrying strap 56 may be used to carry the beverage container carrier 42. The thermally-insulated carrier walls 43, carrier bottom 44 and carrier top 45 of the beverage container carrier 42 thermally insulate the cooling pack 36 and the beverage container 2.

When it is desired to dispense beverage from the beverage container interior 6 of the beverage container 2, the dispensing hose 26 may be attached to the dispensing nozzle 16 through the nozzle cap 18, as was heretofore described with respect to FIG. 1. Accordingly, the canula 29 which is centered in the hose connector 27 pierces the seal 21 which is provided in the nozzle cap 18 to impart a fluid-tight seal between the dispensing nozzle 16 and the dispensing hose 26. The beverage can then be dispensed by gravity from the beverage container interior 6 of the beverage container 2 and through the dispensing hose 26 and spigot 32 into a beverage-receiving vessel (not illustrated) by manipulation of the spigot lever 33. The beverage container interior 6 may be refilled with beverage through the dispensing nozzle 16 or other refilling technique. As liquid beverage is dispensed from the spigot 32, air may flow from the spigot 32 and through the dispensing hose 26, canula 29, nozzle cap 18 and dispensing nozzle 16 and into the beverage container 2, respectively, to prevent vapor lock during dispensing of the beverage.

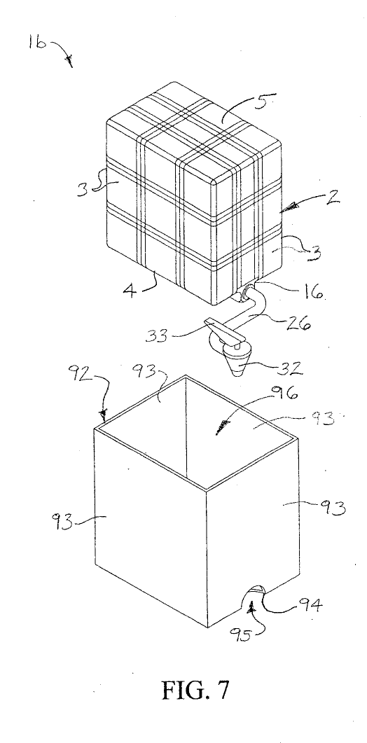

An alternative design for the cooling pack 92 is illustrated in FIG. 7. The cooling pack 92 may include multiple cooling pack side panels 93 and a cooling pack bottom panel 94 provided on the cooling pack side panels 93. A cooling pack interior 96 may be defined by the cooling pack side panels 93 and the cooling pack bottom panel 94. A nozzle slot 95 may be provided at the junction between a cooling pack side panel 93 and the cooling pack bottom panel 94. Accordingly, the beverage container 2 is placed in the cooling pack interior 96 such that the cooling pack side panels 93 and the cooling pack bottom panel 94 cool the beverage contained in the beverage container 2 by conduction. The nozzle slot 95 may accommodate the dispensing nozzle 16 of the beverage container 2. The cooling pack 92 and beverage container 2 placed therein may be placed in the beverage container carrier 42 as was heretofore described with respect to FIG. 3.

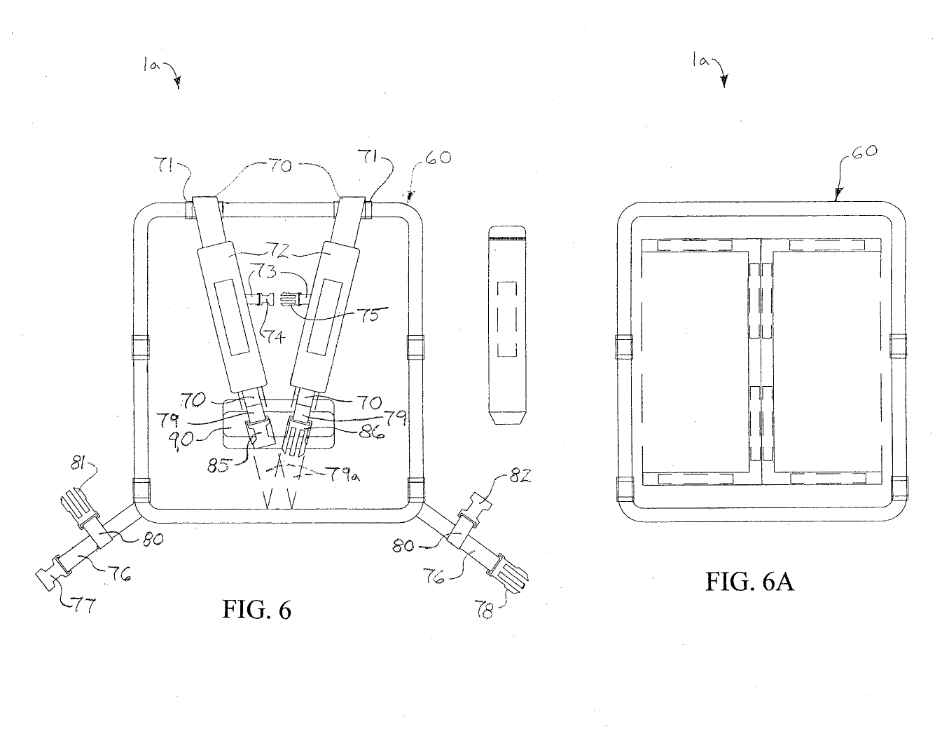

Referring next to FIGS. 4, 6 and 6A of the drawings, an alternative illustrative embodiment of the beverage cooler and dispenser assembly, hereinafter assembly, is generally indicated by reference numeral 1a. The assembly 1a includes a beverage container carrier 60. As illustrated in FIG. 4, the beverage container carrier 60 of the assembly 1a may include carrier walls 67 and a carrier bottom 68 and a carrier top 69 provided on the carrier walls 67. In some embodiments, each of the carrier walls 67, the carrier bottom 68 and the carrier top 69 may include an outer enclosure layer 61, an inner enclosure layer 63 and a middle enclosure layer 62 sandwiched between the outer enclosure layer 61 and the inner enclosure layer 63. In some embodiments, the outer enclosure layer 61 may be a cordura or other insulating material, the middle enclosure layer 62 may be poly-foam or other insulating material and the inner enclosure layer 63 may be cordura or other insulating material or a vinyl-coated or backed material.

As further illustrated in FIG. 4, enclosure partitions 65 may divide the interior of the beverage container carrier 60 into multiple beverage container compartments 66. Each beverage container compartment 66 may be sized and configured to receive a corresponding beverage container 2 and cooling pack 36 (or cooling pack 92 which was heretofore described with respect to FIG. 7). The beverage containers 2 provided in the respective beverage container compartments 66 of the beverage container carrier 60 may each have a design which is similar to that of the beverage container 2 heretofore described with respect to FIGS. 1-3. A nozzle opening 64 may be provided in the carrier walls 67 in communication with each corresponding beverage container compartment 66. Each nozzle opening 64 may accommodate the dispensing nozzle 16 of the beverage container 2 which is contained in the corresponding beverage container compartment 66.

As illustrated in FIG. 6, in some embodiments, a pair of shoulder straps 70 may be provided on the beverage container carrier 60. A first end of each shoulder strap 70 may be attached to the beverage container carrier 60 through a strap grommet 71 or other suitable attachment technique. A second end of each pair of shoulder straps 70 may be reinforced with a strap reinforcement 79, beyond which the shoulder straps 70 may be sewn to the beverage container carrier 60 via stitching 79a or may be otherwise attached to the beverage container 60. Strap pads 72 may be provided on the respective shoulder straps 70. In some embodiments, connecting straps 73 may extend from the respective shoulder straps 70. A female strap connector 74 and a male strap connector 75 may be provided on the respective connecting straps 73. The male strap connector 75 may be selectively inserted in the female strap connector 74 to detachably attach the shoulder straps 70 to each other. A terminal female connector 85 and a terminal male connector 86 may be provided on the ends of the respective shoulder straps 70 for purposes which will be hereinafter described.

A pair of waist straps 76 may be provided on the beverage container carrier 60. A female connector 77 and a male connector 78 may be provided on the respective waist straps 76. A pair of connecting straps 80 may extend from the respective waist straps 76. A male connector 81 and a female connector 82 may be provided on the respective connecting straps 80. Accordingly, the male connector 81 provided on a first one of the connecting straps 80 may be detachably inserted in the companion terminal female connector 85 provided on a first one of the shoulder straps 70. The female connector 82 provided on a second one of the connecting straps 80 may be detachably inserted in the companion terminal male connector 86 provided on the second one of the shoulder straps 70. The male connector 78 provided on a first one of the waist straps 76 may be detachably inserted in the companion female connector 77 provided on the second one of the waist straps 76 to secure the waist straps 76 around the waist (not illustrated) of a wearer. The shoulder straps 70 may be extended over the shoulders of the wearer to secure the beverage container carrier 60 on the wearer. In some embodiments, a lower lumbar support 90 may be provided on the beverage container carrier 60. The lower lumbar support 90 may be poly-foam or other suitable material.

In typical application of the assembly 1a, multiple beverage containers 2, each of which contains a supply of beverage (not illustrated), are contained in the respective beverage container compartments 66 (FIG. 4) of the beverage container carrier 60. Each beverage container 2 may be contained in a corresponding cooling pack 36. The beverage container carrier 60 may be donned by a wearer (not illustrated) by placing the shoulder straps 70 over the respective shoulders of the wearer, attaching the male strap connector 75 into the female strap connector 74, attaching the male connector 81 to the terminal female connector 85 and the female connector 82 to the terminal male connector 86 and fastening the waist straps 76 around the waist of the wearer by attaching the female connector 77 to the male connector 78. Accordingly, the beverage container carrier 60 can be easily transported on the shoulders of the wearer. It will be appreciated by those skilled in the art that the strap pads 72 may impart comfort to the wearer's shoulders. Moreover, in embodiments in which the shoulder straps 70 are attached to the beverage container carrier 60 at the stitching 79a, the shoulder straps 70 are ergonomic and provide a balanced weight distribution of the beverage container carrier 60 of the wearer's shoulders. Additionally, attachment of the shoulder straps 70 using the connecting straps 73 may enhance weight distribution of the beverage container carrier 60 on the wearer's shoulders. The lower lumbar support 90 on the beverage container carrier 60 may provide support to the lower back of the wearer. Therefore, the shoulder straps 70, the waist straps 76 and the connecting straps 80 in conjunction with the lower lumbar support 90 form a harness which distributes weight between the hips and shoulders and away from the spine of the wearer.

When dispensing of beverage from the beverage containers 2 is desired, a dispensing hose 26 and spigot 32 (FIG. 1) may be coupled to one or more of the dispensing nozzles 16 of the beverage containers 2 such as through a nozzle cap 18, as was heretofore described with respect to FIG. 1. It will be appreciated by those skilled in the art that a variety of beverages may be contained in the respective beverage containers 2. Accordingly, the beverages may be dispensed from the beverage container carrier 60 depending on the preferences of the user.

While illustrative embodiments of the disclosure have been described above, it will be recognized and understood that various modifications can be made and the appended claims are intended to cover all such modifications which may fall within the spirit and scope of the disclosure.

What is claimed is:

1. A beverage cooler and dispenser assembly, comprising:
a beverage container having a dispensing nozzle;
a cooling pack receiving the beverage container; and
a beverage container carrier receiving the beverage container and the cooling pack.

2. The beverage cooler and dispenser assembly of claim 1 further comprising a carrying strap provided on the beverage container carrier.

3. The beverage cooler and dispenser assembly of claim 1 wherein the cooling pack comprises a cooling pack connecting panel and a pair of spaced-apart cooling pack side panels extending from the cooling pack connecting panel.

4. The beverage cooler and dispenser assembly of claim 1 wherein the cooling pack comprises a plurality of cooling pack side panels and a cooling pack bottom panel provided on the cooling pack side panels.

5. The beverage cooler and dispenser assembly of claim 1 further comprising a dispensing hose coupled to the dispensing nozzle.

6. The beverage cooler and dispenser assembly of claim 5 further comprising a nozzle cap coupled to the dispensing nozzle and a hose connector provided on the dispensing hose and coupled to the nozzle cap.

7. The beverage cooler and dispenser assembly of claim 6 further comprising a seal provided in the nozzle cap and a canula provided in the hose connector and piercing the seal.

8. The beverage cooler and dispenser assembly of claim 5 further comprising a spigot provided on the dispensing hose and a spigot lever provided on the spigot.

9. A beverage cooler and dispenser assembly, comprising:
a beverage container having a plurality of beverage container walls, a beverage container bottom and a beverage container top defining a beverage container interior;
a dispensing nozzle disposed in fluid communication with the beverage container interior;
a cooling pack receiving the beverage container and having a nozzle slot receiving the dispensing nozzle; and
a beverage container carrier receiving the beverage container and the cooling pack.

10. The beverage cooler and dispenser assembly of claim 9 further comprising at least one nozzle opening provided in the beverage container carrier and receiving the dispensing nozzle.

11. The beverage cooler and dispenser assembly of claim 9 further comprising a structural brace provided in the beverage container interior of the beverage container.

12. The beverage cooler and dispenser assembly of claim 11 wherein the structural brace comprises a main brace panel extending between the beverage container top, the beverage container bottom and a first pair of the beverage container walls and a transverse brace panel intersecting the main brace panel and extending between a second pair of the beverage container walls.

13. The beverage cooler and dispenser assembly of claim 12 further comprising a plurality of beverage flow notches provided in each of the main brace panel and the transverse brace panel.

14. The beverage cooler and dispenser assembly of claim 9 further comprising a carrying strap provided on the beverage container carrier.

15. The beverage cooler and dispenser assembly of claim 9 further comprising a pair of shoulder straps provided on the beverage container carrier.

16. The beverage cooler and dispenser assembly of claim 15 further comprising a pair of waist straps provided on the beverage container carrier and detachably attached to the pair of shoulder straps, respectively.

17. A beverage cooler and dispenser assembly, comprising:
a plurality of beverage containers having a plurality of dispensing nozzles, respectively;
a plurality of cooling packs receiving the beverage containers, respectively; and
a beverage container carrier receiving the beverage containers and the cooling packs.

18. The beverage cooler and dispenser assembly of claim 17 further comprising a plurality of enclosure partitions provided in the beverage container carrier and a plurality of beverage container compartments defined by the enclosure partitions, and wherein the beverage containers and the cooling packs are provided in the beverage container compartments, respectively.

19. The beverage cooler and dispenser assembly of claim 18 further comprising a pair of shoulder straps provided on the beverage container carrier.

20. The beverage cooler and dispenser assembly of claim 19 further comprising a pair of waist straps provided on the beverage container carrier and detachably attached to the pair of shoulder straps, respectively.
